(19) United States
(12) Patent Application Publication
(10) Pub. No.: US 2017/0316117 A1
(43) Pub. Date: Nov. 2, 2017

(54) CONTROLLING THE OUTPUT OF INFORMATION USING A COMPUTING DEVICE

(71) Applicant: PHILIPS LIGHTING HOLDING B.V., EINDHOVEN (NL)

(72) Inventors: RALF GERTRUDA HUBERTUS VONCKEN, EINDHOVEN (NL); LUCA TIBERI, EINDHOVEN (NL); PAUL ANTHONY SHRUBSOLE, ARNHEM (NL); MAURICE HERMAN JOHAN DRAAIJER, ITTERVOORT (NL)

(21) Appl. No.: 15/523,548

(22) PCT Filed: Oct. 23, 2015
(86) PCT No.: PCT/EP2015/074680

§ 371 Date: May 1, 2017

(30) Foreign Application Priority Data
Oct. 30, 2014 (EP) 14191017.4

(51) Int. Cl. G06F 17/50; G06F 1/16; G06F 3/01; G06K 9/00

(52) U.S. Cl. CPC G06F 17/5004; G06K 9/00671; G06F 1/163; G06F 3/011

(57) ABSTRACT

A computing device for controlling the output of information by at least one output device, the computing device comprising: at least one processor and at least one memory including computer program code for one or more programs, the at least one memory and the computer program code configured to, with the at least one processor, cause the computing device to at least: receive sensor information from at least one wearable sensor; identify a situation for the wearer of the at least one wearable sensor using the sensor information; determine an interaction mode for interacting with said wearer based on the identified situation; and select and control, based on the interaction mode, an output device from the at least one output device to provide the information to the user.

### FIELD OF THE INVENTION

This invention is generally related to a method and apparatus for controlling based on a determined interaction mode information by an output device using a computing device, and in particular but not only a method and apparatus for controlling based on the determined interaction mode the output of information by an output device using a computing device for assisting a user of the device to perform a sequence of activities such as lighting installation activities.

### BACKGROUND OF THE INVENTION

Modern electrical, mechanical and plumbing systems are often complex systems which are difficult to install, maintain, and dismantle without significant knowledge of the specific system. A significant amount of effort and time is being invested in creating systems which are easy to install, maintain and dismantle. For example such systems often come with large quantity of installation, operation, and maintenance information often in electronic formats. This information can present a step-by step approach of describing activities in a determined sequence in order to attempt to reduce the amount of errors produced operating the activities. It is understood for example that diagnosing and solving errors made during an installation may lead to significantly higher costs and increases the time needed for completing the building/facility and therefore should be avoided where ever possible.

The availability of the information, type of information and ease of use of this information are all key to reducing errors in these situations. For example installations such as lighting installations may be documented by on-site paper format installation plans. These paper plans are furthermore often on large unwieldy format such as AO size paper installation plans. Furthermore paper documents such as installation manuals and datasheets of devices are difficult to use and may be easily damaged in some environments. As indicated more recently electronic installation manuals and searchable datasheets of devices have been made available to view from a smart device. These smart devices, such as smartphones and tablets, may also be used to receive and view interactive videos/manuals to assist in the activities or sequences of activities such as installation, operation or maintenance of such systems.

Operating these smart devices typically requires a physical interaction (e.g. touch, swipe etc.). As such while the devices can be useful in preparation and reviewing activities they are less useful or become pointless in scenarios in which the installer needs to use both hands in the activity and thus cannot control the smart device.

Wearable smart-devices or wearable computing devices can help users such as installers to receive information at the right time. Innovative user interfaces associated with the wearable smart-devices, for example smart wearable glasses (Google Glass), or smart wearable watches (SmartWatch), can assist in delivering situational information to the user by making use of embedded sensors such as cameras, pressure-sensors, light-sensors, ultra sonic sensors, 3D-sensing sensors, gyroscopes, and microphones. These embedded sensors and the user interface enables the wearable smart device to be operated hands-free (e.g. via voice control). These wearable computing devices can also be networked and have access to the internet (either by having stand-alone access or via smartphone/tablet tethering). As such they have access to all the needed information repositories.

This access to information may itself cause problems. A user (for example an installer) may need to regularly switch between types of information on a single device or may need to interact with many different smart devices in order to get the information needed for that particular activity. This switching between devices and information may distract the user and allow potential accidents such as electrocution, falling from a height, cuts, burns, or eye injuries to occur.

Furthermore wearable smart devices in order to be usefully worn are equipped with small batteries. Typically the wearable smart devices and the sensors associated with the device are maintained in an on state in order to anticipate their use throughout the whole of the operation or process. Thus for example the wearable smart device is on throughout the whole of the lighting system sequence of activities. Where the operation or process is complex and long the user may need to replace batteries or swap the computing device for a fully charged one during the operation or process potentially causing delays in the operation or process.

### SUMMARY OF THE INVENTION

The above concern is addressed by the invention as defined by the claims.

According to an aspect of the invention, there is provided a computing device for controlling the output of information by at least one output device, the computing device comprising: at least one processor and at least one memory including computer program code for one or more programs, the at least one memory and the computer program code configured to, with the at least one processor, cause the computing device to at least to: receive sensor information from at least one wearable sensor; identify a situation for the wearer of the at least one wearable sensor using the sensor information, wherein said situation is identified from at least one of a position, posture and/or movement adopted by the wearer when performing an activity; and an environmental condition of an environment in which the wearer is performing said activity; determine an interaction mode for interacting with said wearer based on the identified situation, and select and control, based on the interaction mode, an output device from the at least one output device to provide information to the wearer to assist the wearer in performing the activity.

In such embodiments by determining a suitable interaction mode based on an identified situation the correct output device by which information or types of information can be output to the wearer.

The information may be situational information. The computing device may be further configured to: communicate with the at least one memory or a further device to retrieve further information relevant to the identified situation; filter the further information based on the interaction mode to generate situational information. In such embodiments therefore the computing device may be able to access information or data from any suitable source including external sources or further devices such as cloud based information sources. Furthermore these embodiments as discussed herein permit the processing or filtering of information, for example information associated with a sequence of activities, such that the interaction mode determines which information is to be output or delivered to the wearer and how it is to be output or delivered.

Determining the interaction mode may comprise selecting one of: an information interaction mode, wherein the information is planning or support information associated with the situation; and an instruction interaction mode, wherein the information is instruction information associated with an action associated with the situation. Thus these example modes of interaction may be used within a situation which would be used to control the output of situational information to the wearer.

The computing device may further be configured to select at least one of the at least one output device to provide the situational information based on the determined interaction mode. Thus in such embodiments a suitable output device or channel for the situational information can be selected based on the interaction mode. Furthermore in such embodiments the at least one output devices are further controlled, for example activated or deactivated, based on the interaction mode.

The computing device may comprise the at least one output device. The computing device may be in communication with the at least one output device located separately from the computing device. The at least one output device may be a wearable output device.

The computing device may further be configured to select and control at least one of: an audio transducer configured to output audio information; a display configured to output image information; a display configured to output image information over a captured image of an wearers field of view; a see through display configured to output image information over an wearers field of view; and a tactile transducer configured to output tactile information. Thus in such embodiments a range of suitable output devices may be employed to output the information.

The computing device may be further configured to: identify an activity associated with the identified situation; and select and control the output device from the at least one output device to provide the information further based on the identified activity associated with the situation. In such embodiments the current activity associated with the identified situation may furthermore be used to filter or process the information. Thus for example during an installation activity the device may determine whether the activity has been started, been partially performed or completed and provide suitable information such as indicating where to install the item, how to connect the item, and how to switch on the installed item.

The computing device may further be configured to: determine a risk factor associated with the identified situation; and determine the interaction mode further based on the risk factor. In such embodiments a risk factor determination may be performed before determining the interaction mode. Thus for example a first ‘low-risk’ factor may be associated with the situation associated with installing a lighting unit on the ground which determines a first ‘low-risk’ installation mode where a rich mix of information such as incoming text messages and installation information for this lighting unit and surrounding lighting units. Whereas a situation associated with installing a lighting unit high off the ground may generate a second ‘high-risk’ factor and which determines a ‘high-risk’ installation mode which significantly reduces the information passed to the wearer.

The at least one wearable sensor may be a plurality of position sensors embedded within at least one garment worn by the wearer and wherein the computer device configured to identify a situation for the wearer of the at least one wearable sensor using the sensor information from the at least one wearable sensor may be configured to: identify a posture of the wearer using the plurality of position sensors; and use the identified posture of the wearer to identify the situation. In such a manner the situation may be determined by the posture of the wearer. The posture may be in turn determined from sensors embedded within clothing or other garments worn by the wearer.

The at least one wearable sensor may be a height sensor and wherein the computing device configured to identify a situation for the wearer of the at least one wearable sensor using sensor information from the at least one wearable sensor from the position of the wearer when performing an activity may be configured to: identify the height of the wearer using the height sensor; and use the identified height of the wearer to identify the situation.

The at least one wearable sensor may be a camera and wherein the computing device may be configured to: receive a captured image from the camera; identify within the image a feature; and use the identified feature to identify the situation.

The at least one wearable sensor may be at least one of: at least one camera configured to capture an image from the viewpoint of the wearer; at least one microphone configured to capture an audio signal; a gyroscope/compass sensor input configured to capture movement of the wearer; an atmospheric pressure sensor input; a pressure, bend or contact sensor input associated with a garment worn by a wearer configured to determine a shape or posture of the wearer wearing the garment.

The at least one output device may be a head mounted display and wherein the computing device configured to select and control, based on the determined interaction mode, the at least one output device to provide the information to the wearer may be further configured to output at least one image of information to the wearer via the head mounted display.

The at least one output device may be at least one audio transducer and wherein the computing device may be further configured to output auditory information to the wearer via the audio transducer.

The computing device may be configured to control at least one of the wearable sensors based on the determined situation or interaction mode. In such a manner power consumption of the battery levels of the computing device or wearable sensors coupled to the computing device may be controlled and optimised.

The computing device may comprise at least one of: a google glass device; a head mounted display; a smart watch; a smartphone; an interactive earplug.

The computing device may comprise the at least one wearable sensor. The computing device may be coupled to the at least one wearable sensor by a wireless connection. The computing device may be coupled to the at least one wearable sensor by a wired connection. The computing device may comprise a transceiver configured to receive the sensor information from the at least one wearable sensor.

The computing device may comprise the at least one output device. The computing device may be coupled to the at least one output device by a wireless connection. The computing device may be coupled to the at least one output device by a wired connection. The computing device may comprise a transceiver configured to communicate and control the at least one output device.

According to a second aspect of the invention, there is provided a method for controlling using a computing device the output of information by at least one output device, the method comprising: receiving sensor information from at least one wearable sensor; identifying a situation for the wearer of the at least one wearable sensor using the sensor information, wherein said situation is identified from at least one of a position, posture and/or movement adopted by the wearer when performing an activity; and an environmental condition of an environment in which the wearer is performing said activity; determining an interaction mode for interacting with said wearer based on the identified situation; and selecting and controlling based on the interaction mode, an output device from the at least one output device to provide the information to the wearer to assist the wearer in performing the activity.

In such embodiments by determining a suitable interaction mode based on an identified situation the correct situation related information or type of information can be output to the wearer and furthermore the correct or suitable output device or mode of output used to deliver this information.

The information may be situational information. The selecting and controlling, based on the interaction mode, the at least one output device to provide the information to the wearer may further comprises: communicating with at least one memory or a further device to retrieve further information relevant to the identified situation; and filtering the further information based on the interaction mode to generate the situational information.

Determining the interaction mode may comprise selecting one of: an information interaction mode, wherein the information is planning or support information associated with the situation; and an instruction interaction mode, wherein the information is instruction information associated with an action associated with the situation. Thus these example modes of interaction may be used within a situation which would be used to control the output of situational information to the wearer.

Thus in such embodiments a suitable output device or channel for the situational information can be selected based on the interaction mode. Furthermore in such embodiments the output devices are further controlled, for example activated or deactivated, based on the interaction mode.

The selecting and controlling based on the interaction mode, the output device from the at least one output device to provide the information to the wearer may further comprise selecting and controlling at least one of: an audio transducer configured to output audio information; a display configured to output image information; a display configured to output image information over a captured image of an wearers field of view; a see through display configured to output image information over an wearers field of view; and a tactile transducer configured to output tactile information. Thus in such embodiments a range of suitable output devices may be employed to output the information.

The identifying a situation may further comprise: identifying an activity associated with the identified situation; and selecting and controlling the output device from the at least one output device to provide the information further based on the identified activity associated with the situation. In such embodiments the current activity associated with the identified situation may furthermore be used to filter or process the situational information. Thus for example during an installation activity the method may determine whether the activity has been started, been partially performed or completed and provide suitable situational information such as indicating where to install the item, how to connect the item, and how to switch on the installed item.

The determining an interaction mode may further comprise: determining a risk factor associated with the identified situation; and determining the interaction mode further based on the risk factor.

The receiving of sensor information from the at least one wearable sensor may comprise receiving sensor information from a plurality of position sensors embedded within at least one garment worn by the wearer and wherein identifying a situation for the wearer of the at least one wearable sensor using the sensor information may comprise: identifying a posture of the wearer using the plurality of position sensors; and using the identified posture of the wearer to identify the situation. In such a manner the situation may be determined by the posture of the wearer. The posture may be in turn determined from sensors embedded within clothing or other garments worn.

The receiving of sensor information from the at least one wearable sensor may comprise receiving sensor information from a height sensor and wherein identifying a situation for the wearer of the at least one wearable sensor using sensor information may comprise: identifying the height of the wearer using the height sensor; and using the identified height of the wearer to identify the situation.

The receiving at least one sensor information may comprise receiving sensor information from a camera and wherein identifying a situation for the wearer of the at least one wearable sensor may comprise: receiving a captured image from the camera; identifying within the image a feature; and using the identified feature to identify the situation.

The receiving at least one sensor information may comprise receiving sensor information from at least one of: at least one camera configured to capture an image from the viewpoint of the wearer; at least one microphone configured to capture an audio signal; a gyroscope/compass sensor input configured to capture movement of the wearer; an atmospheric pressure sensor input; a pressure, bend or contact sensor input associated with a garment worn by a wearer configured to determine a shape or posture of the wearer wearing the garment.

The at least one output device may be a head mounted display and wherein selecting and controlling the output device may comprise outputting at least one image of situational information to the wearer via the head mounted display.

The at least one output device may be at least one audio transducer and wherein the selecting and controlling the output device may comprise outputting auditory situational information to the wearer via the audio transducer.

The method may comprise controlling at least one of the wearable sensors based on the determined situation or interaction mode. In such a manner power consumption of therefore battery levels of the wearable device or sensors coupled to the computing device may be controlled and optimised.

A computer program product may comprise a computer-readable medium embodying computer program code for implementing the steps of the method as described herein when executed on a processor of a computing device. Such a computer program product may be made available to the computing device in any suitable form, e.g. as a software application (app) available in an app store, and may be used to configure the computing device such that the computing device can implement the aforementioned method.

A computing device may comprise: the computer program product as described herein; a processor adapted to execute the computer program code; at least one sensor; and at least one output device for providing situational information.

The activity associated with a situation may comprise at least one of: a sequence of activities for connecting a device or system; a sequence of activities for wiring a device or system; a sequence of activities for configuring a device or system; a sequence of activities for assembling a device or system; a sequence of activities for disassembling a device or system; a sequence of activities for powering a device or system; a sequence of activities for controlling a device/system; and a sequence of activities for linking a device or system to a network.

### BRIEF DESCRIPTION OF THE DRAWINGS

Examples of the invention will now be described in detail with reference to the accompanying drawings, in which:

FIG. 1 shows a system comprising an example computing device according to some embodiments;

FIG. 2 shows an example computing device processor operating as a controller according to some embodiments;

FIG. 3 shows a flow diagram of the operation of the example computing device according to some embodiments;

FIGS. 4a and 4b show an example system comprising a computing device in operation;

FIG. 5 shows a flow diagram of the example system in FIGS. 4a and 4b; and

FIG. 6 show a further flow diagram of an example system in operation.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, a computing device as described herein may be a wearable computing device or wearable smart device. The computing device as described herein in the following examples furthermore is a wearable computing device within which is integrated at least one sensor (a wearable sensor) suitable for monitoring the user or wearer of the wearable sensor. Furthermore the wearable computing device as shown in the following examples comprises an integrated output device (a wearable output device), such as a see-through display which is configured to permit the outputting of situational information to the wearer. Situational information is information relevant to an identified situation of the user or wearer. It is understood that the situation of the user or wearer of the at least one wearable sensor may be a situation defined with respect to the user or wearer. For example the wearer may have a situation defined by the position of the wearer, sitting down, standing up, reaching etc. Furthermore it is understood that the situation of the user or wearer may be a situation defined with respect to the environment within which the wearer is operating. For example the wearer may have a situation defined by the current height off the ground of the wearer/user, the noise or light levels of the wearer's environment etc. Furthermore it is understood that the situation may be defined with respect to combinations of environmental conditions and the wearers own situation independent of the environmental conditions. In other words, in at least some embodiments the situation of a user may be considered a context in which the user operates, which context can be used to determine in what form information is provided to the user. The form may relate to the output medium as well as to the information itself, e.g. the information may be adjusted based on the context, i.e. the information may be tailored as contextual information.

It should be understood that the computing device shown in the following examples is an example only of one possible implementation and that the computing device is not necessarily a wearable computing device but may be any suitable computing device, i.e. may not be worn by or located on the user. In such embodiments the computing device may be in wireless or wired communication with at least one wearable sensor (or sensor located on the user). Furthermore in some embodiments the output device as described herein may be similarly (wired or wirelessly) coupled or connected to the computing device and as such may not be worn by the user or located on the user.

A computing device or smart device is a device that provides a user with computing functionality and that can be configured to perform specific computing tasks as specified in a software application (app) that may be retrieved from the Internet or another computer-readable medium. A wearable computing device may be any device designed to be worn by a user on a part of the user's body and capable of performing computing tasks in accordance with one or more aspects of the present invention. Non-limiting examples of such wearable computing devices include smart headgear, e.g. eyeglasses, goggles, a helmet, a hat, a visor, a headband, or any other device that can be supported on or from the wearer's head. The examples described herein describe controlling of situational information to assist a user of the computing device to perform a lighting installation sequence of activities. However it is understood that the computing device as described herein may be employed to assist a user in any suitable matter relating to the identified situation and based on the determined interaction mode.

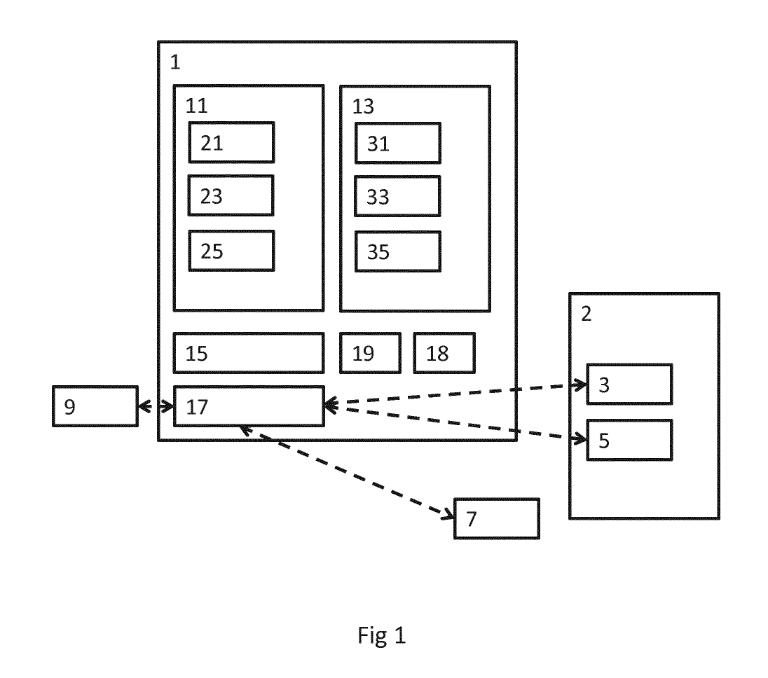

With respect to FIG. 1 an example system including a wearable computing device as an example of a computing device 1 according to some embodiments is shown. The wearable computing device is shown in the following example being able to perform a method for controlling the output of situational information to assist a user of the device. The wearable computing device is further shown in the following examples as comprising at least one sensor 11 and at least one output device 13 for providing situational information. Furthermore there is as described as follows a method with the computing device comprising: identifying a situation using the sensor information from the at least one sensor; determining an interaction mode associated with the computing device based on the identified situation, wherein the interaction mode may be configured to permit the selecting and controlling of the at least one output device to provide the situational information to the user.

The system comprises a computing device 1. The computing device 1 in the following examples is wearable computing device such as a smart glasses or head mounted display with integrated sensors device (such as sold as the google glass system). However it would be understood that any suitable computing device or smart device can be implemented as the computing device 1.

The computing device 1 may comprise or be coupled to at least one output device 13. For example in some embodiments the computing device 1 comprises a see-through display 33, e.g. a head mounted display. The see-through display 33 makes it possible for a user of the computing device 1 to look through the see-through display 33 and observe a portion of the real-world environment, i.e., in a particular field of view provided by the see-through display 33 in which one or more of the lighting units of the lighting system to be installed are present.

In addition, the see-through display 33 may be operable to display images that are superimposed on the field of view, for example, an image of a desired lighting plan, lighting unit installation tutorials to be applied to the one or more lighting units in the field of view. Such an image may be superimposed by the see-through display 33 on any suitable part of the field of view. For instance, the see-through display 33 may display such an image such that it appears to hover within the field of view, e.g. in the periphery of the field of view so as not to significantly obscure the field of view.

The see-through display 33 may be configured as, for example, eyeglasses, goggles, a helmet, a hat, a visor, a headband, or in some other form that can be supported on or from the wearer's head. The see-through display 33 may be configured to display images to both of the wearer's eyes, for example, using two see-through display units. Alternatively, the see-through display 33 may include only a single see-through display and may display images to only one of the wearer's eyes, either the left eye or the right eye.

A particular advantage associated with such a see-through display 33, e.g. a head mounted display, is that the wearer of the display may view an actual site for performing the job, such as a lighting installation site. In other words the user may view a space or part thereof where the at least one of the lighting units of the lighting system are to be installed through the see-through display 33. In other words the see-through display 33 is a transparent display, thereby allowing the user to view the lighting installation site in real-time.

In some embodiments the see-though display 33 may be substituted or enhanced by a conventional display such as a LCD, LED or organic LED display panel mounted in front of one of the user's eyes.

In some embodiments the computing device 1 may include or be coupled to other output devices 13. For example the computing device 1 may further comprise or be coupled to an output device for producing audio output such as at least one acoustic transducer 31. The acoustic transducers may be air or bone conduction transducers and may be in any suitable form such as earbuds, earphones, or speakers.

In some embodiments the computing device 1 may further comprise or be coupled to an output device for producing a tactile output such as produced by a tactile actuator or vibra 35. The tactile actuator or vibra 35 may for example be configured to vibrate or move a surface in contact with the user which is detected by the user.

Furthermore in some embodiments the computing device 1 further comprises or is coupled to at least one sensor 11. The sensor 11 can be any suitable wearable sensor. For example as shown in FIG. 1 the at least one sensor 11 may comprise at least one microphone or sound sensor 21 configured to capture acoustic signals from the area surrounding the computing device 1. It is understood that in some embodiments there may be more than one microphone and that in some embodiments the microphones are spatially arranged such that directional audio capture is possible. Furthermore in some embodiments the sound sensors or microphones may be configured to enable directional audio signal processing to be performed, for example noise reduction processing. The microphones may be any suitable type of microphone including air conduction or surface contact microphones. The output of the sound sensors 21 may be used for example to detect spoken instructions by the user.

The computing device 1 may further be coupled to or include an image capturing device 23, e.g. a camera, as a sensor. The image capturing device 23 may be configured to capture images of the environment the user particular point-of-view. The images could be either video images or still images. In some embodiments, the point-of-view of the image capturing device 23 may correspond to the direction in which the see-through display 33 is facing. In these embodiments, the point-of-view of the image capturing device 23 may substantially correspond to the field of view that the see-through display 33 provides to the user, such that the point-of-view images obtained by image capturing device 23 may be used to determine what is visible to the wearer through the see-through display 33.

Examples of further sensors 11 which may be worn by the user and coupled to the computing device or integrated to the computing device 1 further include at least one motion sensor 25, such as an accelerometer or gyroscope or electronic compass, for detecting a movement of the user. Such a user-induced movement for instance may be recognized as a command instruction or to assist in determining the situation of the wearer or user as will be explained in more detail below.

However the at least one sensor 11 may comprise any suitable sensor. For example atmospheric pressure sensors configured to identify the user's height based on atmospheric pressure.

Furthermore in some embodiments the computing device 1 may be provided in the form of separate devices of which one part may be worn or carried by the user. The separate devices that make up computing device may in some embodiments be communicatively coupled together in either a wired or wireless fashion.

Furthermore in some embodiments the computing device 1 may be coupled to a wearable sensor. This is shown with respect to FIG. 1 by the glove or pair of gloves 2. The glove or pair of gloves 2 may form part of the system and comprise wearable sensors 3 are separate from the computing device 1. An example of a suitable sensor 3 to be embedded within the gloves may be pressure sensors configured to determine whether the wearer is gripping an object or bend sensors to determine the posture of the user (or the user's hands). The pressure/bend sensors may be implemented by the use of a piezoelectric sensor.

Furthermore in some embodiments the computing device may be coupled to a further wearable output device. This is shown in FIG. 1 by the glove(s) 2 furthermore comprising output devices 5, also separate from the computing device 1 main part. An example output device 5 associated with the glove 2 may be at least one tactile actuators such as a piezo-electric actuator 5 located at a finger tip of the glove and configured to provide a tactile output. The glove(s) 2 may in some embodiments comprise a further transceiver part configured to transmit and receive data, for example from the computing device 1. Furthermore in some embodiments the glove(s) 2 may further comprise a processor and associated memory for processing and storing sensor data and output device data.

Although the example of glove(s) 2 are provided herein it would be understood that the separate parts may be implemented within any suitable garment, such as t-shirt, trousers, shirt, skirt, undergarments, headgear or footwear, and so on.

In some embodiments, the computing device 1 includes a communications interface 17, for enabling communication within the device and to other devices. Thus the communications interface 17 may be an interface for receiving sensor information or data or outputting suitable control information or data to output devices. The communications interface may be a wired interface, for example for internal device communication. The communications interface may comprise a wireless communications interface or transceiver for wirelessly communicating with other parts of the system, such as the glove(s) shown in FIG. 1. The communications interface 17 may furthermore optionally be configured to communicate with further networks, e.g. a wireless LAN, through which the computing device 1 may access a remote data source 9 such as the Internet or a server and/or a further smart device 7. Alternatively, the computing device 1 may include separate wireless communication interfaces that are able to communicate with the other parts of the system and the further networks. The transceiver 17 may be any suitable transceiver such as for example a Wi-Fi transceiver, a mobile data or cellular network transceiver, or a Bluetooth transceiver.

The functioning of computing device 1 may be controlled by a processor 15 that executes instructions stored in a non-transitory computer readable medium, such as data storage 19. The data storage 19 or computer readable storage medium may for example include a CD, DVD, flash memory card, a USB memory stick, a random access memory, a read only memory, a computer hard disk, a storage area network, a network server, an Internet server and so on.

The processor 15 in combination with processor-readable instructions stored in data storage 19 may function as a controller of the computing device 1. As such, for example, the processor 15 may be adapted to control the display 33 in order to control what images are displayed by the display 33. The processor 15 may further be adapted to control the wireless communication interface or transceiver 17.

In addition to instructions that may be executed by processor 15, data storage 19 may store data for the provision of suitable situational information, such as any activities or sequence of activities that are expected to be performed. For instance, the data storage 19 may function as a database of identification information related to the lighting units to be installed, tutorials of how to install the lighting units etc. Such information may be used by the computing device 1 to provide the situational information as described herein.

The computing device 1 may further include a user interface 18 for receiving input from the user. The user interface 18 may include, for example, a touchpad, a keypad, buttons, a microphone, and/or other input devices. The processor 15 may control at least some of the functioning of computing device 1 based on input received through user interface 18. For example, the processor 15 may use the input to control how the see-through display 33 displays images or what images the see-through display 33 displays, e.g. images of a desired lighting site plan selected by the user using the user interface 18.

In some embodiments, the processor 15 may also recognize gestures, e.g. by the image capturing device 23, or movements of the computing device 1, e.g. by motion sensors 25, as control instructions.

In some examples, a gesture corresponding to a control instruction may involve the wearer physically touching an object, for example, using the wearer's finger, hand, or an object held in the wearer's hand. However, a gesture that does not involve physical contact, such as a movement of the wearer's finger, hand, or an object held in the wearer's hand, toward the object or in the vicinity of the object, could also be recognized as a control instruction.

Although FIG. 1 shows various components of wearable computing device, i.e., wireless communication interfaces 17, processor 15, data storage 19, one or more sensors 11, image capturing device 23 and user interface 18, as being separate from see-through display 33, one or more of these components may be mounted on or integrated into the see-through display 33. For example, image capturing device 23 may be mounted on the see-through display 33, user interface 18 could be provided as a touchpad on the see-through display 33, processor 15 and data storage 19 may make up a computing system in the see-through display 33, and the other components of wearable computing device could be similarly integrated into the see-through display 33.

The processor 15 functioning as a controller may further be configured in some embodiments to receive the sensor information from the sensors 11 and process this sensor information according to instructions or programs stored on the data storage 19 or memory. For example in some embodiments the processor 15 may be configured to process the data from the at least one sensor 11 in order to determine a situation experienced by the user. The situation in some embodiments may be an activity from a known or predetermined sequence of activities. This determination of a situation as described herein in further detail may be achieved by using the sensor information to identify the situation. For example the identification of the situation may be achieved by comparing the sensor information against a lookup table of determined sensor values associated with specific situations. A situation may therefore be identified by the computing device from the sensor information provided by the at least one (wearable) sensor. For example the situation may in some embodiments be a posture or movement linked with activities or a sequence with activities performed by the wearer or user of the at least one sensor. However in some embodiments the situation may be a posture or movement of the wearer of the at least one wearable sensor and is not linked with any specific activity or sequence of activities. Furthermore in some embodiments the situation may identify that the wearer or user is operating within a certain type of environment or surroundings, i.e. environment of surroundings exhibiting particular environmental conditions. For example a situation may be an identification that the wearer of the wearable sensor is within a noisy environment, a low light or low visibility environment, or a poor quality air environment, to give but a few examples of such environmental conditions

In order to assist understanding of the embodiments example situations are described herein. The situations in this example are situations associated with activities performed during an installation job' which may be assisted by the computing device. The example lighting unit installation job' may have or comprise a determined situation associated with activities of

1: identify and select the ‘next’ lighting unit to be installed—‘identifying’ situation

2: install the selected lighting unit by climbing to the desired location for the ‘next’ lighting unit and plug in the lighting unit to the available structure—‘installing’ situation.

These two situations may be repeated during the activity of installing the light units until all of the lighting units have been installed.

Furthermore with respect to this example the processor 15 operating as a controller may be configured to receive sensor information from an atmospheric pressure sensor (height sensor) worn by the user and therefore providing a sensor value associated with a height of the user above the ground. The processor 15 may further be configured to determine or identify a situation based on the sensor information. In this example the processor may be configured to determine from the sensor information whether the current situation (which in this example is associated with an activity) is the identifying or the installing situation. In this example the situation may be identified based on the height value, where a first situation is identified when the height value is a ‘ground’ level (the first situation being associated with the activity of selecting the next light unit to be installed while the user is on the ground) and the second situation, the installing situation, is identified when the height is a level higher than ground level (the second situation being associated with an activity of climbing up to install the lighting unit at its desired location). In some embodiments the processor operating as a controller may be configured to determine the current situation based on a previously determined situation. In other words in some embodiments the determination of the current situation may be performed based on memory of previously determined situations. For example where it is known that the installing situation always follows the identifying situation then once the processor determines that the current situation is an identifying situation then the processor may be configured to compare the sensor values against expected sensor values for the installing situation only. Although the example shown herein uses one sensor input to identify or determine the situation it is understood that more than one sensor or type of sensor input may be used. For example the identification of the situation may be based on a combination of inputs from various sensors or sensor types.

Furthermore in some embodiments the processor 15 may be configured to then determine an interaction mode for the computing device based on the identified situation. For example the first, ‘identifying’, situation may be associated with the computing device requiring or setting an information interaction mode. The situational information to be output when the computing device is operating in an information interaction mode may be planning or support information associated with the identified situation. This planning information may be for example information with respect to the lighting units. Furthermore the second, ‘installing’, situation may be associated with the computing device requiring or setting an instruction interaction mode. The situational information to be output when the computing device is operating in an instruction interaction mode may be instruction information associated with the action of performing the identified situation. For example a tutorial describing where and how the next luminaire is to be located within the support structure.

Having determined the interaction mode for the computing device 1 the processor 15 may then be configured to select and control the type of information to be output based on the determined interaction mode. Furthermore the processor 15 may be configured to select an output device 13 (for example the see-through display 33, the audio transducer 31 or tactile transducer 35) to provide the situational information to the user to assist the user (for example to assist the user in performing the activity associated with the situation) based on the determined interaction mode. The interaction mode in other words determines how situational information is to be presented to the user, what situational information is to be presented to the user and can further be used to control both sensor activity and output device activity.

The computing device 1 as described herein is configured to be used to assist the user. The assistance to the user may be in order to prevent the user from suffering information overloading in difficult or dangerous situations. Or the assistance may be information provided in a suitable manner so to help the user in performing a sequence of activities. The sequence of activities can be any suitable mechanical, electrical, or plumbing operation such as installing a mechanical, electrical or plumbing system, maintaining or preparing a mechanical, electrical or plumbing system, or dismantling or removing a mechanical, electrical 1 or plumbing system. In other words in the situation of the present invention a sequence of activities can be any arrangement of steps or processes which are to be completed to finish a ‘job’ or procedure. Thus for example some examples can be connecting a device or system, wiring a device or system, configuring a device or system, assembling a device or system, disassembling a device or system, powering a device or system, controlling a device or system, or linking a device or system to a network.

In some embodiments the processor 15 performing as a controller may be configured to further determine the status or progress of a situation based on the at least one sensor. The determination of the interaction mode may then be based on not only the identified situation but also the status or progress of the situation.

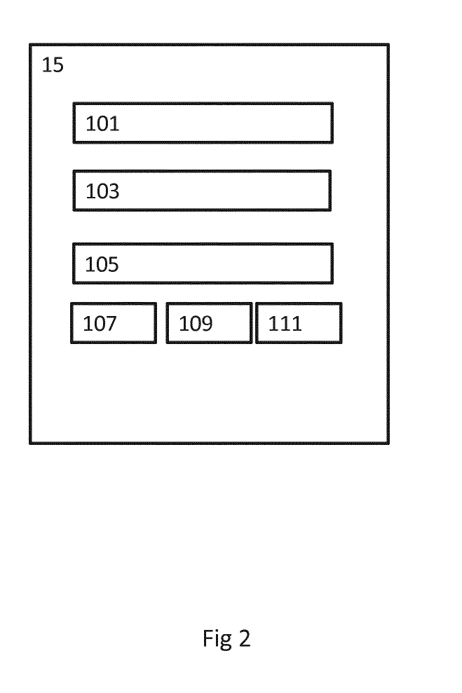

With respect to FIG. 2 an example processor 15 is shown in further detail with respect to operational modules suitable for implementing some embodiments. The operational modules as shown herein with respect to the processor 15 may represent computer code, programs or parts of computer code or programs stored within the memory 19 and implemented or executed within the processor 15. However it would be understood that in some embodiments at least one of the operational modules may be implemented separately from the processor 15 or the processor 15 represents more than one processor core processor core configured to perform the operational module. The processor 15 in some embodiments comprises a sensor input 101. The sensor input in some embodiments is configured to receive the sensor input or sensor information from the sensor(s) 11 and/or and external sensors such as the pressure or contact sensor 3 in the glove(s) 2. Furthermore the sensor input 101 in some embodiments is configured to filter the sensor inputs and/or control whether the sensors are active or inactive based on the current interaction mode.

The processor 15 may further comprise a situation identifier 103. The situation identifier 103 in some embodiments is configured to receive the filtered sensor input signals and determine the current situation being performed from the filtered sensor input signals. It would be understood that in some embodiments the situation identifier 103 is further configured to further determine the whether the situation is associated with an activity or current sequence of activities being performed. Furthermore in some embodiments the situation identifier 103 may, having determined the situation is associated with an activity or sequence of activities, then determine the situation or activity location within the sequence. Furthermore in some embodiments the situation identifier 103 (or activity or status determiner which may be implemented within the situation identifier 103) is configured to determine the status of the situation based on the filtered sensor input signals. In some embodiments the situation identifier 103 is configured to map or associate information from the sensor information or input signals to a specific situation. This may be performed according to any known manner including pattern recognition of sensor information, conditional or memory based pattern recognition, regression processing of sensor information, Neural network analysis of sensor information, etc. In the simple example given above with respect to the lighting system installation the situation identifier 103 may be configured to receive the height related sensor information and map the sensor information to a first, ‘identifying’, situation when the height value is less than a determined threshold value and map the sensor information to a second, ‘installing’, situation when the height value is equal to or greater than a determined threshold value.

In some embodiments the processor 15 may also comprise a risk determiner (which may be implemented within the situation identifier). The risk determiner may be configured to determine a risk factor or element associated with the current situation based on the filtered sensor input signals. Using the lighting system installation example a low risk factor may be associated with the installation situation when the user is close to the ground level, in other words the height value is greater than the threshold for identifying a change of situation from identifying situation to installing situation (for example >2 m) but less than a determined risk threshold (>5 m). Whereas a higher risk factor may be associated with the installation situation when the situation is identified as occurring high above the ground and therefore higher than the determined risk factor (>5 m).

The processor 15 may further comprise an interaction mode determiner or identifier 105. The interaction mode determiner 105 may be configured to receive the identified situation (and furthermore in some embodiments, the identified activity or sequence of activities, the identified status associated with the identified situation, and the risk factor) and based on this input determine a suitable interaction mode. In some embodiments interaction mode determiner 105 may be configured to apply a look up table which has multiple entries and generate or output a suitable interaction mode identifier based on the entry value representing the identified situation (and furthermore in some embodiments at least one of the identified activities, sequence of activities, the identified status or progress of the activity associated with the identified situation, and the risk factor). However any suitable manner of determining an interaction mode from the identified situation (and in some embodiments the further input parameters) may be implemented. Using the lighting installation example described herein the interaction mode determiner may be configured to determine or select an information interaction mode when the identified situation is the ‘identifying’ or ‘selecting’ the lighting unit situation, and determining or selecting an instruction interaction mode when the identified situation is the ‘installing’ situation.

The processor 15 in some embodiments comprises an information situation filter 107. The information situation filter 107 may receive information associated with or related to the identified situation (and/or the identified activity and/or the status of the current activity) and be configured to filter this information based on the determined interaction mode. The information may be retrieved or received either from data storage 19 within the computing device 1 or as described herein from external devices such as server 9 or any other suitable storage device external to the computing device 1. The information content filter 107 may then be configured to output the filtered information.

Using the lighting installation system example described above the information associated with an identified situation may include a range of differing types of information such as tutorials on how to install a particular lighting unit, information of the lighting unit plan, other supporting information about the lighting units, or safety information associated with operating at ‘height’. The information situation filter 107 may be configured to filter this information such that the output situational information may be tutorials on how to install a particular lighting unit for a determined instruction interaction mode. Whereas the information content filter 107 may be configured to filter the information such that the output situational information is the lighting plan information enabling the user to select the next lighting unit to be installed for a determined information mode interaction mode.

The processor 15 in some embodiments may comprise an output device selector or controller 109. The output device controller 109 may be configured to determine which of the output devices or output channels are going to be activated based on the determined interaction mode. Furthermore in some embodiments the output device controller 109 may be configured to determine which of the output devices are to output the situational information based on the determined interaction mode. Using the lighting installation example described herein the output device controller 109 may be configured to enable the output of the installation tutorial on how to install a particular lighting unit by the audio transducers only and disable the video part of the tutorial. This output device selection may for example be performed when interaction mode based on the situation or the risk factor is one which indicates that it would be dangerous to obscure the users vision and causes a ‘risk of danger instruction interaction mode’ to be determined. Similarly the output device controller 109 may be configured to enable the output of the installation tutorial on how to install a particular device using video only, in other words only outputting the video part of the tutorial. This may be performed when the interaction mode is one which indicates that the identified situation occurs within a noisy environment and as such the audio content would not be heard over the background noise of the environment.

The processor 15 in some embodiments may comprise a sensor controller 111. The sensor controller may be configured to determine which of the sensor input channels is to be filtered by the sensor input filter 101 based on the determined interaction mode. Furthermore the sensor controller 111 may be configured to control the sensors, to activate or deactivate the sensors based on the determined interaction mode. For example the sensor controller 111 can be configured to disable or deactivate the microphone when the interaction mode is one which indicates that the user or current situation is occurring within a noisy environment and as such can save or reduce the power consumption of the computing device 1. The sensor controller 111 may then be configured to re-enable the microphone when the interaction mode is one which indicates that the user has ‘left’ the noisy environment.

Thus for example the controller 15 may be configured to receive indicators from the glove(s) when the user is holding the light unit and when the user has released the light unit after it is been installed. In some embodiments where the computing device or garment comprises integrated sensors configured to detect the posture or shape of the user this sensor information may be used to determine when the user is standing, sitting, crouched, or other and therefore determine the current situation of the user based on the identified posture or shape. For example a user crouching down to pick up the next luminaire or lighting unit may have a first posture which is detected by the controller 15 as being an situation such as selecting the next lighting unit whereas a user standing up right and stretched may have a second posture which is detected by the controller as being an situation such as reaching to install the next lighting unit. It would be understood that the user crouching and selecting and picking up the next luminaire is likely to be able to receive a much richer environment of information as compared to a user stretching or reaching to install a lighting unit and therefore not wanting to be disturbed from doing the current situation. As such the controller can determine different interaction modes for the selecting and picking up situation as compared to the reaching and installing situation.

Alternatively or additionally, the sensor controller 111 may be configured to control the sensors as a function of the detected situation, as for different situations different sets of sensors may need to be operational. For instance, the sensors may be switched on/off or put in a standby mode based on the situation. For example, a limited number of sensors may be active to sense a general property of a situations (e.g. moving or not), after which other sensors may be switched on to provide further details on the situation (what type of movement), such that the sensor configuration as controlled by the sensor controller 111 may be dynamically adjusted as a function of a detected situation.

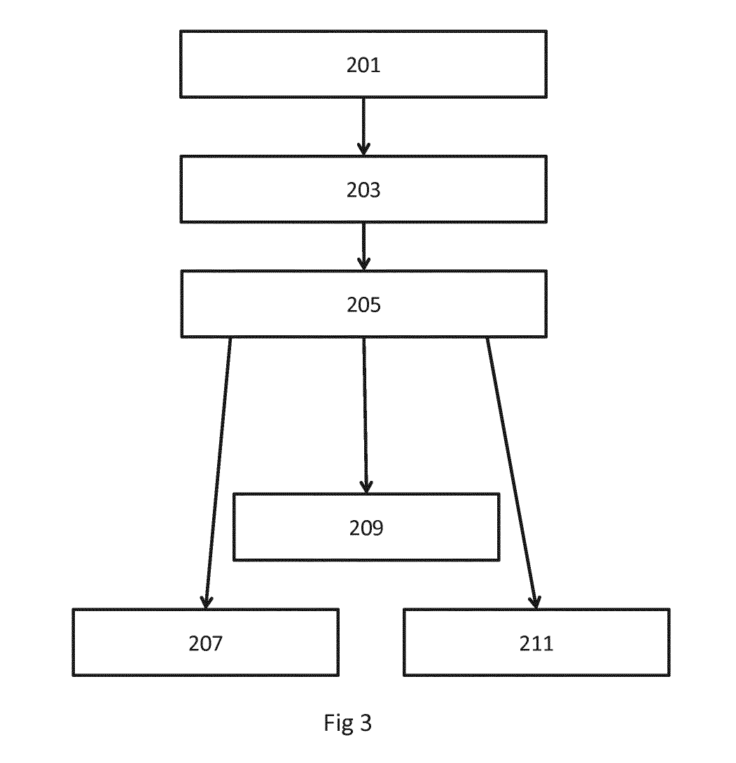

With respect to FIG. 3 an example flow diagram of the operation of the processor shown in FIGS. 1 and 2 according to some embodiments is described.

As indicated herein the processor may be configured to receive (and optionally filter) sensor information. The sensor information may for example be sensor information from at least one wearable sensor which may be an integrated sensor and/or external sensor.

The operation of receiving (and filtering) sensor information is shown in FIG. 3 by step 201.

Furthermore the processor may be configured to identify a situation for the wearer of the at least one wearable sensor using the sensor information. In some embodiments processor may be configured to further identify a status of the situation and/or the risk associated with the situation. Furthermore the processor may be configured to identify the sequence of activities associated by the identified situation.

The operation of identifying the situation for the wearer of the at least one wearable sensor using the sensor information is shown in FIG. 3 by step 203.

The processor may further be configured to then determine an interaction mode for interacting with said wearer based on at least the identified situation.

The operation of determining the interaction mode for interacting with the wearer is shown in FIG. 3 by step 205.

The processor may in some embodiments be configured to filter information or situational information based on the determined interaction mode.

The operation of filtering information or situational information based on the interaction mode is shown in FIG. 3 by step 207.

Furthermore in some embodiments the processor may be configured to select and control an output device from the at least one output device to provide the information or situational information to the wearable device to assist the user in performing the situation.

The operation of selecting and controlling an output device from the at least one output device to provide the situational information based on the interaction mode is shown in FIG. 3 by step 209.

Furthermore in some embodiments the processor may be configured to control the sensors (such as controlling a filtering of the sensor information from the sensors or controlling the activation or deactivation of the sensors).

The operation of controlling the sensors based on the interaction mode is shown in FIG. 3 by step 211.

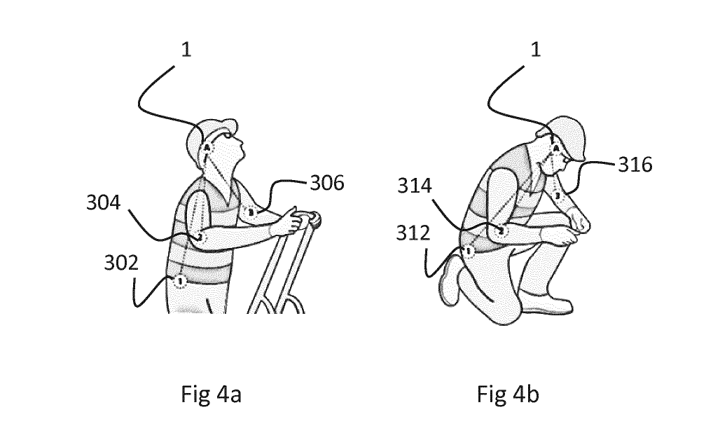

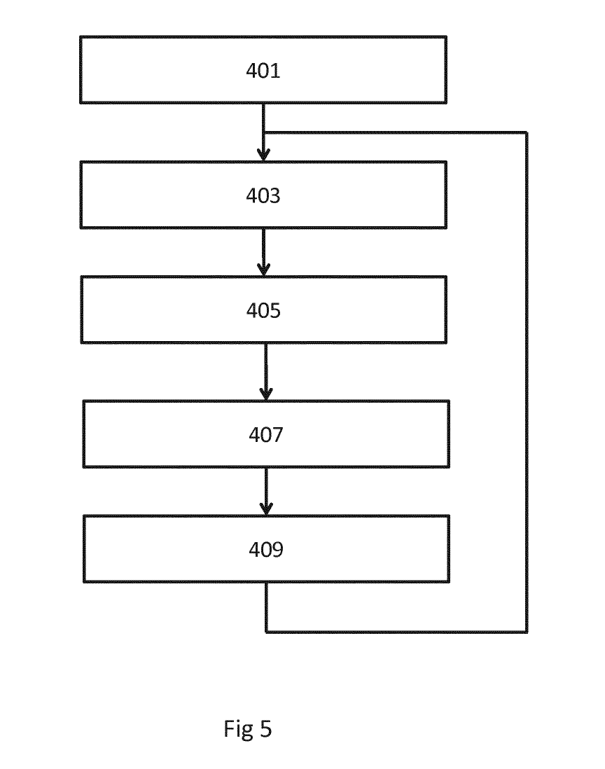

With respect to FIGS. 4a and 4b and 5 is shown a further example of embodiments with respect to a further lighting unit installation ‘job wherein the sensor information is that generated from bend or pressure sensors within a safety vest or garment determining the posture of the user operating the computing device.

With respect to FIG. 4a, the user operating the computing device is shown climbing a ladder, and the wearable sensors comprise sensors 302, 304, and 306 embedded within the safety vest located on the wearer's torso, right arm elbow joint, and left arm elbow joint respectively. These sensors have, while the wearer is in this posture, a first sensor arrangement. With respect to FIG. 4b, where the wearer is shown crouching and examining or looking downwards, the sensors 312, 314, and 316 embedded within the safety vest located on the user's torso, right arm elbow joint, and left arm elbow joint respectively have a second sensor arrangement.

For the following example the wearer as shown in FIG. 4a is attempting a lighting unit ‘installing’ situation whereas the user shown in FIG. 4b is attempting a lighting unit ‘identifying’, selecting and picking up situation.

With respect to FIG. 5 a flow diagram is shown of the operations of the computing device according to an example switching between an information mode of interaction and an instruction mode of interaction (where the instruction mode could also be known as an information mode). The computing device 1 for example may be configured to identify that a situation related to installing a lighting unit are being performed.

The operation of identifying that a lighting installation situation is beginning is shown in FIG. 5 by step 401.

The user may, in attempting to identify the next lighting unit to be installed, adopt the posture shown in FIG. 4b. The sensors 312, 314 and 316 may provide the positional information to the computing device 1. The computing device 1 receiving the sensor information may then identify the posture from the sensor information therefore be configured to identify the situation being performed is the ‘identifying’ (and selecting) situation.

The operation of identifying the situation as the ‘identifying’ situation based on the posture sensor information is shown in FIG. 5 by 403.

The computing device 1 may then be configured to determine an interaction mode based on the identified ‘identifying’ situation. This for example may be an information interaction mode. The determination of an ‘information’ interaction mode may be configured to control the information received or stored on the computing device such that it generates or filters information about the light fittings, displays the lighting plan and outputs this lighting plan and information on the light fittings to the display such that the user can identify the next lighting unit to be selected.

The operation of determining the interaction mode and selecting and controlling the situational information based on the interaction mode is shown in FIG. 5 by 405.

The user or wearer of the sensor having identified the next lighting device may then select and pick up the lighting device and climb a ladder in order to install at the next lighting device at the suitable position. This is represented by the wearer adopting the position shown in FIG. 4a. The array of ‘position’ sensors 302, 304 and 306 may provide the posture or positional information to the computing device 1. The computing device 1 receiving the sensor information may then determine that the wearer is attempting to install the selected next lighting unit and therefore be configured to identify the situation being performed is that of ‘installing’ the next lighting unit.

The operation of determining the ‘installing’ situation based on the posture sensor information is shown in FIG. 5 by step 407.

The computing device 1 can then be configured to determine a further interaction mode based on the identified installation situation. For example in this situation the interaction mode based on the installation situation may be an installation/instruction mode. The determination of the installation/instruction mode may be configured to control the information received or stored on the computing device 1 such that it generates or filters information about the light units, and displays either visually or audibly a tutorial or instruction on how to install the selected lighting unit and where to install the selected lighting unit. In such a manner the wearer is assisted in his situation as only the information required by the wearer of the wearable sensor is output in a manner that does not confuse or overwhelm the user.

The operation of determining the installation interaction mode and selecting and controlling the situational information based on the installation interaction mode is shown in FIG. 5 by 409.

Once the user has installed the lighting unit and descended down the ladder the wearer may once again readopt the position in FIG. 4b in attempting to identify and select the next lighting unit to be installed and as such the operation may loop back to step 403 where an identification and selection action is identified again.

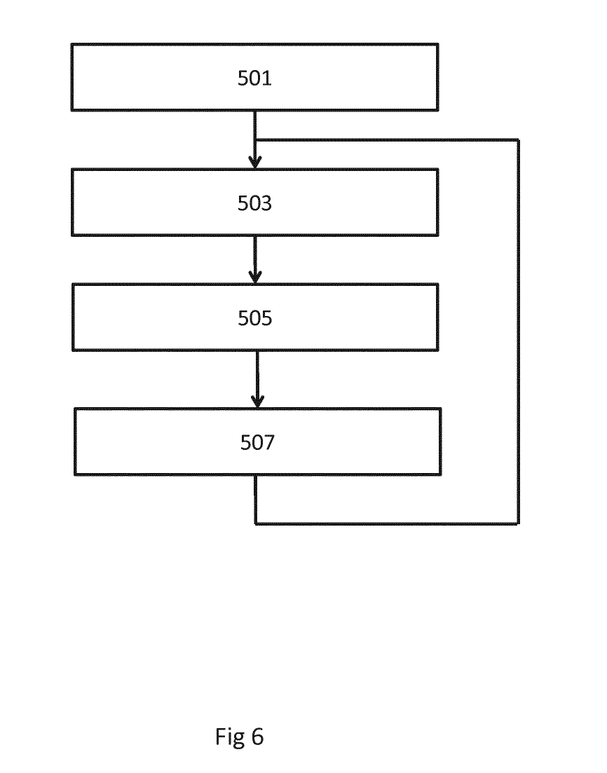

With respect to FIG. 6 a further example is shown wherein the sensor is the image capturing device in the form of a camera. In this example the camera is configured to be selected to be activated.

The operation of the activating the camera is shown in FIG. 6 by step 501.

The camera may then be configured to capture at least one image.

The operation of capturing an image using the camera is shown in FIG. 6 by step 503.

Furthermore the image captured by the sensor may be passed to the processor 15. The processor 15 may then be configured to process the image in order to attempt to determine a feature within the image. The feature may for example be at least one determined shape, colour or light intensity. Thus for example in some embodiments a first feature may be a lighting unit identified by the shape or colour or a tag such as a bar code or QR code on the lighting unit, a second feature may be the support structure also identified by shape, colour or tag.

The operation of identifying within the image a feature is shown in FIG. 6 by step 505.

The processor 15 may then be configured to then use the identified feature to identify the at least one situation. For example the identification of the lighting unit may be associated with the ‘identify and select next lighting unit’ situation when the wearer is attempting to identify and select the next lighting unit to install. Whereas the identification of the support structure may be associated with the ‘installation’ situation as the wearer is looking where to install the selected lighting unit. It is understood that as described herein following the identification of the situation being performed the processor may then determine an interaction mode for the computing device and then furthermore control the output of situational information based on the determined interaction mode.

The operation of associating the identified feature with the situation, to identify the situation being performed is shown in FIG. 6 by step 507.

Furthermore following the identification of the situation the operation may then loop back to capturing further images in order to determine whether a new situation has occurred.

Although the embodiments and described examples have indicated that the determined interaction mode controls the output of situational information associated with the identified context it would be understood that in some embodiments the interaction mode may control all types of information output from the computing device 1. For example the interaction mode may control other communication outputs, for example setting the computing device in a hands free mode, a silent mode, a call divert mode based on the determined interaction mode.

Furthermore although the examples described herein show where the interaction mode controls the output of information on the computing device 1 it would be understood that the interaction mode can be used to control the output of information on external devices. Thus for example where a computing device and tablet device are used in combination the input and output capabilities can be combined to enrich the interaction information delivery. Thus for example the tablet device could be used to view information when the user has the ability to operate the tablet with both hands, for example when the wearer of the wearable sensor is in the position shown in FIG. 4b and the computing device display used to view information when the wearer does not have the ability to operate the tablet with both hands, for example when the wearer is in the position shown in FIG. 4a. By offering seamless transitions and combination of interaction modes the user is able to operate the safest mode of interaction and therefore prevents information overload or confusion which may provide or produce accidents such as electrocution, falling from a height, cuts, burns or other injuries.

Furthermore in general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although these are not limiting examples. While various aspects described herein may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments described herein may be implemented by computer software executable by a data processor of the apparatus, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, e.g. a CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments as discussed herein may be practiced in various objects such as integrated circuit modules. The design of integrated circuits is by and large a highly automated process. Complex and powerful software tools are available for converting a logic level design into a semiconductor circuit design ready to be etched and formed on a semiconductor substrate.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A computing device for controlling, during an installation activity, the output of information by at least one output device, the computing device comprising:
at least one processor, and
at least one memory including computer program code for one or more programs;
wherein the processor is configured to
receive sensor information from at least one wearable sensor;
identify a situation of the wearer of the at least one wearable sensor using the sensor information and the one or more programs stored on the at least one memory, wherein said situation is identified from at least one of:
a position, posture and/or movement adopted by the wearer when performing the installation activity; and
an environmental condition of an environment in which the wearer is performing said installation activity;
select an interaction mode for interacting with said wearer based on the identified situation; and
identify the installation activity associated with the identified situation; and
select and control, based on the interaction mode and based on the identified installation activity, an output device from the at least one output device for providing information to the wearer to assist the wearer in performing the installation activity; and,
control, based on the determined interaction mode or as function of the detected situation, at least one of the at least one wearable sensor.

2. The computing device of claim 1, further configured to:
communicate with the at least one memory or a further device to retrieve further information relevant to the identified situation; and
filter the further information based on the interaction mode to generate situational information; and
select and control the output device to provide the situational information to the wearer.

3. The computing device of claim 1, further configured to:
determine a risk factor associated with the identified situation; and
determine the interaction mode further based on the risk factor.

4. The computing device of claim 1, wherein the at least one wearable sensor is a plurality of position sensors embedded within at least one garment worn by the wearer, and wherein the computing device is configured to:
identify a posture of the wearer using the plurality of position sensors; and
use the identified posture of the wearer to identify the situation.

5. The computing device of claim 1, wherein the at least one wearable sensor is a height sensor and wherein the computing device configured to identify a position of the wearer is configured to:
identify the height of the wearer using the height sensor; and
use the identified height of the wearer to identify the situation.

6. The computing device of claim 1, wherein the at least one wearable sensor is a camera and wherein the computing device is configured to:
receive a captured image from the camera;
identify within the image a feature;
use the identified feature to identify the situation.

7. The computing device of claim 1, wherein the at least one output device is a see-through display and wherein the computing device is further configured to output at least one image of information to the wearer via the see-through display.

8. The computing device of claim 1, wherein the at least one output device is at least one audio transducer and wherein the computing device is further configured to output auditory information to the wearer via the audio transducer.

9. (canceled)

10. The computing device of claim 1, wherein the computing device is a wearable computing device further comprising the at least one wearable sensor and/or the at least one output device.

11. A method for controlling using a computing device, during an installation activity, -the output of information by at least one output device, the method comprising:
receiving sensor information from at least one wearable sensor;
identifying a situation for the wearer of the at least one wearable sensor using the sensor information where said situation is identified from at least one of:
a position, posture and/or movement adopted by the wearer when performing the installation activity; and
an environmental condition of an environment in which the wearer is performing said installation activity;
selecting an interaction mode for interacting with said wearer based on the identified situation; and
identifying the installation activity associated with the identified situation; and
selecting and controlling based on the interaction mode and based on the identified installation activity, an output device from the at least one output device for providing the information to the wearer to assist the wearer in performing the activity; and
controlling, based on the determined interaction mode or as function of the detected situation, at least one of the at least one wearable sensor.

12. The method of claim 11, further comprising:
communicating with at least one memory or a further device to retrieve further information relevant to the identified situation; and
filtering the further information based on the interaction mode to generate situational information; and selecting and controlling the output device to provide the situational information to the wearer.

13. The method of claim 11, wherein receiving at least one sensor information may comprise receiving sensor information from an plurality of position sensors embedded within at least one garment worn by the user and wherein identifying a situation using the at least one sensor information comprises:
identifying, a posture of the wearer; and
using the identified posture of the wearer to identify the situation.

14. The method of claim 11, wherein receiving at least one sensor information comprises receiving sensor information from a camera and wherein identifying a situation using the at least one sensor information comprises:
receiving a captured image from the camera;
identifying within the image a feature; and
using the identified feature to identify the situation.

15. (canceled)

16. The computing device of claim 1, wherein said interaction mode is one of: an information interaction mode for providing planning or support information associated with the situation; and an instruction interaction mode for providing instruction information associated with an installation action associated with the situation.
